(19) United States
(12) Patent Application Publication
(10) Pub. No.: US 2026/0097966 A1
(43) Pub. Date: Apr. 9, 2026

(54) METHODS OF PRODUCING ANODE ACTIVE MATERIALS AND GRAPHENE FROM GRAPHITE

(71) Applicant: NanoXplore Inc., Montreal (CA)

(72) Inventors: Nima MOGHIMIAN, Saint Laurent (CA); Soroush NAZARPOUR, Saint-Laurent (CA)

(21) Appl. No.: 19/349,676

(22) Filed: Oct. 3, 2025

Related U.S. Application Data
(60) Provisional application No. 63/703,917, filed on Oct. 5, 2024.

(51) Int. Cl. C01B 32/225; C01B 32/19; H01M 4/36; H01M 4/587; H01M 4/62; H01M 10/42

(52) U.S. Cl. CPC C01B 32/225; C01B 32/19; H01M 4/366; H01M 4/587; H01M 4/62; H01M 10/4235; C01P 2004/03; C01P 2004/32; C01P 2004/51; C01P 2004/61; C01P 2006/12; C01P 2006/40; C01P 2006/80

(57) ABSTRACT

Embodiments described herein relate to systems and methods for converting graphite compositions into spherical graphite particles and graphene. In some aspects, a method can include providing a graphite composition, and subjecting the graphite composition to a spheronization process to produce a plurality of spherical graphite particles and a plurality of graphite particles rejected from the spheronization process. The method further includes separating and collecting the spherical graphite particles and the rejected graphite particles in different collection zones. The rejected graphite particles are then exfoliated to obtain graphene particles. The spherical graphite particles are then further processed to form anode-active materials. The method can further include reducing an average particle size of the graphite composition via a micronization process prior to spheronization.

### CROSS-REFERENCE TO RELATED APPLICATION

This application claims priority to and the benefit of U.S. Provisional Application No. 63/703,917, filed on Oct. 5, 2024, and entitled “Methods of Producing Anode Active Materials and Graphene from Graphite”, the content of which is hereby incorporated by reference in its entirety.

### TECHNICAL FIELD

Embodiments described herein relate to systems and methods for producing spherical graphite particles and graphene particles from a feedstock graphite composition.

### BACKGROUND

Spherical graphite is widely used in various applications, particularly in energy storage systems such as lithium-ion batteries (LIBs) and supercapacitors. Unlike traditional graphite, which typically has a flake-like structure, spherical graphite features a rounded shape that enhances packing density and electrical conductivity, resulting in improved energy storage capacity and efficiency. For example, spherical graphite is commonly utilized in the anodes of lithium-ion batteries, where it facilitates desired lithium ion intercalation, contributing to better overall battery performance.

The production of spherical graphite typically involves several mechanical steps (e.g., milling, grinding, and/or the like), where traditional flake graphite is ground into a finer particle size and shaped into spherical particles. However, the production of spherical graphite presents several challenges, particularly in terms of resource efficiency and environmental impact. The mechanical shaping process, which involves multiple stages of milling and classification, often results in considerable material loss (exceeding 30% of the graphite feedstock by weight). This inefficiency drives up production costs and reduces the overall resource efficiency of the process. In addition, although the final spherical graphite output is relatively small compared to the raw material input, the overall carbon footprint remains substantial, exacerbating the environmental impact.

### SUMMARY

Embodiments described herein relate to methods and systems for converting a graphite feedstock into a plurality of spherical graphite particles and a plurality of graphene particles.

In some aspects, provided herein is a method including subjecting a graphite composition to a spheronization process to produce a plurality of spherical graphite particles and a plurality of graphite particles. The method further includes separating the plurality of spherical graphite particles from the plurality of graphite particles, and collecting the plurality of spherical graphite particles in a first collection zone, and the plurality of graphite particles in a second collection zone different from the first collection zone. The plurality of graphite particles are rejected from the spheronization process. The method also includes exfoliating the plurality of graphite particles collected in the second collection zone to produce a plurality of graphene particles. In some embodiments, the method can further include reducing an average particle size of the graphite composition via a micronization process prior to subjecting the graphite composition to the spheronization process. In some embodiments, the method can include purifying the plurality of spherical graphite particles after collecting the plurality of spherical graphite particles in the first collection zone. In some embodiments, the method can include coating a surface of the plurality of spherical graphite particles (e.g., with a carbon-including composition) to form a plurality of coated spherical graphite particles.

In some aspects, provided herein is a system including a classifier configured to feed a plurality of spherical graphite particles and a plurality of graphite particles rejected from a spheronization process into an airstream, a first collection zone configured to receive the plurality of spherical graphite particles from the classifier, and a second collection zone configured to receive the plurality of graphite particles from the classifier. The second collection zone is different from the first collection zone. The airstream is configured to form at least two different particle trajectories to separate the plurality of spherical graphite particles from the plurality of graphite particles based on at least one of their size, shape, or density. In some embodiments, the system can further include one or more collection zone(s) configured to receive a plurality of spherical graphite particles having a different particle size D50 than the particle size D50 of the plurality of spherical graphite particles received in the first collection zone.

### BRIEF DESCRIPTION OF THE DRAWINGS

FIG. 1 is a flow diagram of a method of producing spherical graphite particles and graphene particles from a feedstock graphite composition, according to an embodiment.

FIG. 2 is a flow diagram of a method of post-processing spherical graphite particles obtained by the method described in FIG. 1, according to an embodiment.

FIG. 3 is a scanning electron microscopy (SEM) image of spherical graphite particles, according to an embodiment.

FIG. 4 is a SEM image of graphite particles rejected from a spheronization process, according to an embodiment.

FIG. 5 is a SEM image of graphene particles, according to an embodiment.

### DETAILED DESCRIPTION

The methods and systems described herein present a promising environmental, social, and governance profile by reducing greenhouse gas (GHG) emissions and waste, thereby addressing sustainability challenges in battery technology and materials production. Traditional methods of spherical graphite and graphene production are associated with high GHG due to energy demands and waste generation. In contrast, the embodiments described herein utilize nearly all the graphite feedstock (e.g., 90% or more) to produce spherical graphite and graphene particles, lowering waste and energy consumption. This results in reduced carbon emissions for both products.

The production of spherical graphite and graphene particles from a graphite feedstock, as described herein, typically involves two main steps: (1) micronization (optional); and (2) spheronization. These process steps aid in developing spherical particles with a proper shape and size. Graphite subject to these process steps can have an appropriate size distribution and can develop a round, granular, and/or spherical shape. Spheronization of graphite generates round, granular particles, but some of the round particles are still too small to be used as anode material since they do not meet strict surface area and tap density requirements of such particles in the electrode production industry. Rejected particles from the spheronization process can often have average dimensions of about 10 μm or less. During the transformation from a flake shape to a sphere, some of the rejected particles have broken and become too small to be usable as anode particles. Some rejected particles can have an edge-trimmed flake shape. Some rejected particles can have a shape of cuboids with rounded corners. Some of the rejected particles can be incompletely rounded. Some of the rejected particles are fully rounded but are too small to make an acceptable anode particle.

Spherical graphite is utilized as an anode material in lithium-ion batteries due to its desired conductibility and stability. The spherical shape of the graphite particles enhances battery performance by providing a higher packing density and better conductivity than flake graphite. Additionally, the spherical structure offers a lower surface area, which contributes to longer cycle life and improved stability in battery applications relative to flake-shaped graphite. To produce spherical graphite, a graphite feedstock typically undergoes a series of mechanical processing, such as grinding, milling and/or the like. Depending on the desired particle size distribution and sphericity, the yield of usable spherical graphite can vary from 20% to 70%, meaning that a substantial portion of the input graphite (i.e., feedstock graphite) is left as byproduct or waste. Consequently, a considerable portion—up to 80% —of the input graphite can become waste or byproduct, which cannot be effectively monetized or reused. This inefficiency also contributes to the overall carbon footprint of battery production.

In some embodiments described herein, a method can include subjecting a graphite composition to a spheronization process to produce spherical graphite particles and graphite particles. The method further includes separating and collecting the spherical graphite particles and the graphite particles rejected from the spheronization process in different collection zones. The spherical graphite particles are then further processed to form anode-active materials. The rejected graphite particles are then exfoliated to obtain graphene particles. The method can further include reducing an average particle size of the graphite particles via a micronization process prior to subjecting the graphite composition to the spheronization process. Embodiments described herein allow for producing both spherical graphite anode material and graphene from the same graphite feedstock, thereby reducing byproducts and enhancing overall resource efficiency.

The systems and methods described herein can address inefficiencies in the production of spherical graphite by collecting and processing its byproducts to form graphene particles. These systems and methods facilitate the conversion of graphite feedstock into both spherical graphite and graphene particles, reducing waste generation. The methods described herein can accommodate variations in the yield of spherical graphite production, allowing manufacturers to adjust their processes based on specific requirements. Even when yields fluctuate, any remaining material that would typically be considered waste can be repurposed to produce graphene particles. As a result, over 90% of the output from the methods presented herein are usable and marketable. By minimizing the generation of unusable byproducts, the systems and methods described herein directly tackle the inefficiencies of traditional methods. Furthermore, they lower production costs by transforming what would otherwise be waste into valuable graphene.

Meanwhile, graphene, which consists of a single layer of carbon atoms arranged in a hexagonal lattice, has various applications, including in electronics, thermal management, coatings, and battery technology. Its remarkable electrical, mechanical, optical, and electrochemical properties allow for improvements in the performance of electrodes. However, conventional graphene production methods can be expensive, energy-intensive, and associated with environmental impacts, making large-scale graphene use challenging for many industries. Embodiments disclosed herein offer a significant advantage by utilizing the same graphite feedstock for both spherical graphite and graphene production. This integrated approach lowers the overall cost of graphene production and mitigates emissions typically associated with graphene manufacturing. By converting waste from spherical graphite production into graphene, the process reduces the carbon footprint and increases material utilization, making graphene production more economically viable and environmentally sustainable.

As used herein, the term “thinned graphite” refers to crystalline graphite that has had its thickness reduced to a thickness from about a single layer of graphene to about 1,200 layers, which is roughly equivalent to about 400 nm. As such, single layer graphene sheets, few-layer graphene (FLG) sheets, and in general multi-layer graphene sheets with a number of layers about equal to or less than 1,200 graphene layers can be referred as thinned graphite.

As used herein, the term “few-layer graphene” (FLG) refers to crystalline graphite that has a thickness from about 1 graphene layer to about 10 graphene layers.

As used herein, the term “D50” refers to the cumulative 50% size on a volume basis (D50), which is the dimension at the point of 50% on the cumulative curve when the cumulative curve is plotted (e.g., the particle diameter at the 50th percentile (median) of the particle volume), such that a particle size distribution is obtained on a volume basis and the total volume is 100%.

As used herein, “average particle size” refers to an average distance across a 3-dimensional particle. For a spherical particle, an average particle size would refer to the spherical particle's diameter. For an irregularly shaped particle, the average particle size would refer to the average distance across the particle across all imaginary lines running through the center of mass of the particle.

As used herein, the term “lateral size” or “lateral sheet size” relates to the in-plane linear dimension of a crystalline material. For example, the linear dimension can be a radius, diameters, width, length, diagonal, etc., if the in-plane shape of the material can be at least approximated as a regular geometrical object (e.g., circle, square, etc.). If the in-plane shape of the material cannot be modeled by regular geometrical objects relatively accurately, the linear dimension can be expressed by characteristic parameters as is known in the art (e.g., by using shape or form factors).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

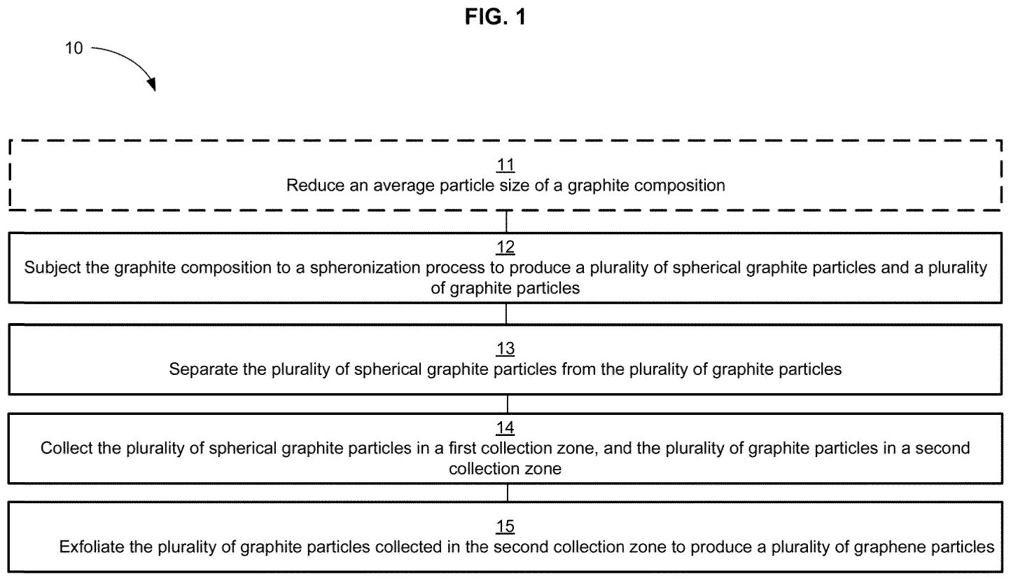

FIG. 1 is a flow diagram of a method of producing spherical graphite and graphene particles, according to an embodiment. The method 10 can optionally include reducing an average particle size of a graphite composition (e.g., a graphite feedstock) via a micronization process, at step 11. The method 10 includes subjecting the graphite composition to a spheronization process to produce a plurality of spherical graphite particles and a plurality of graphite particles, at step 12, and separating the plurality of spherical graphite particles from the plurality of graphite particles rejected from the spheronization process, at step 13. The method 10 further includes collecting the plurality of spherical graphite particles in a first collection zone, and the plurality of graphite particles in a second collection zone different from the first collection zone, at step 14. The method 10 further includes exfoliating the plurality of graphite particles (also referred to as rejected graphite particles) to produce a plurality of graphene particles, at step 15.

At step 11, the micronization process (also referred to as “the micronization”) can be optionally performed prior to the spheronization process to decrease the average particle size of the graphite composition. As such, step 11 can facilitate the refinement of the graphite composition to a size appropriate (e.g., from about 5 μm to about 25 μm) for use in battery anode applications.

In some embodiments, the graphite composition can include a plurality of graphite particles. In some embodiments, the plurality of graphite particles included in the graphite composition can be made of at least one of a natural graphite, or a synthetic graphite. That is, the graphite composition can be derived from various sources, including at least one of a natural or a synthetic graphite. In some embodiments, the synthetic graphite, such as bio-graphite, may be included in the graphite composition, either alone or in combination with natural graphite flakes.

In some embodiments, the graphite composition may have a purity level of about 94% or more by weight. The method 10 can also accommodate a graphite composition with higher purity levels, such as 95%, 96%, 97%, 98%, 99%, or higher by weight, as well as lower purity levels, such as 80%, 85%, 90%, or lower by weight, without affecting the overall process. Impurities in the graphite composition can include non-carbon materials such as silica (SiO₂), iron oxides (e.g., Fe₂O₃), aluminum oxides (Al₂O₃), calcium oxides (CaO), and magnesium oxides (MgO). Other trace elements like sulfur, phosphorous, and/or the like may also be present.

In some embodiments, the graphite composition may have a purity level of 99.50%, 99.51%, 99.52%, 99.53%, 99.54%, 99.55%, 99.56%, 99.57%, 99.58%, 99.59%, 99.60%, 99.61%, 99.62%, 99.63%, 99.64%, 99.65%, 99.66%, 99.67%, 99.68%, 99.69%, 99.70%, 99.71%, 99.72%, 99.73%, 99.74%, 99.75%, 99.76%, 99.77%, 99.78%, 99.79%, 99.80%, 99.81%, 99.82%, 99.83%, 99.84%, 99.85%, 99.86%, 99.87%, 99.88%, 99.89%, 99.90%, 99.91%, 99.92%, 99.93%, 99.94%, 99.95%, 99.96%, 99.97%, 99.98%, or 99.99%. Higher purity levels of graphite can lead to the production of high-purity graphene, which may enhance its effectiveness as a conductive additive in batteries. As the purity of the graphite increases, electrical conductivity and electrochemical performance of the resulting graphene can be enhanced. This improvement could facilitate faster electron transport and more efficient charge and discharge cycles. Additionally, high-purity graphene derived from graphite with higher purity levels might contribute to a longer cycle life for batteries by reducing resistance and enhancing overall stability. Therefore, utilizing graphite with higher purity levels in the composition can be beneficial for optimizing battery performance, particularly in applications that require rapid energy transfer and durability.

In some embodiments, the plurality of graphite particles included in the graphite composition can include crystalline graphite. As used herein, the term “crystalline graphite” refers to graphite-based material of a crystalline structure with a size configured to allow ball milling in a ball milling jar. For example, the crystalline graphite can be layered graphene sheets with or without defects, such defects comprising vacancies, interstitials, line defects, etc. The crystalline graphite may come in diverse forms, such as but not limited to ordered graphite including synthetic crystalline graphite, natural crystalline graphite, pyrolytic graphite (e.g., highly ordered pyrolytic graphite (HOPG)), graphite fiber, graphite rods, graphite minerals, graphite powder, flake graphite, any graphitic material modified physically and/or chemically to be crystalline, and/or the like. As another example, the crystalline graphite can be graphite oxide.

In some embodiments, the graphite composition can include thinned graphite. In some embodiments, the graphite composition may bypass traditional classification, such that unclassified graphite after undergoing basic processing like mining and drying can be directly provided into the method 10 without the need for sieving or screening. Without being bound by a theory, this flexibility can allow manufacturers to source graphite from a wider range of suppliers and reduce the need for costly preprocessing steps such as sieving or mesh classification, thereby lowering operational costs and improving scalability. Conventionally, graphite is classified into different mesh sizes to meet application-specific requirements, with mesh size of 100 μm or finer typically used for spherical graphite production. However, the method 10 provided herein allows for the use of a graphite composition with varying particle sizes. The output ratios of spherical graphite to graphene (e.g., weight or mole ratio) can be adjusted based on the particle size distribution of the feedstock graphite composition.

The plurality of graphite particles included in the graphite composition have a thickness and an average particle size. In some embodiments, the plurality of graphite particles can have an average particle size of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, or at least about 350 μm. In some embodiments, the plurality of graphite particles included in the graphite composition can have an average particle size of no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced particle sizes are also possible (e.g., at least about 10 μm and no more than about 400 μm or at least about 20 μm and no more than about 50 μm). In some embodiments, the plurality of graphite particles included in the graphite composition can have an average particle size of about 10 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, or about 400 μm.

In some embodiments, the plurality of graphite particles included in the graphite composition can have a thickness of at least about 150 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 10 μm, at least about 15 μm, at least about 20 μm, at least about 25 μm, at least about 30 μm, at least about 35 μm, at least about 40 μm, or at least about 45 μm. In some embodiments, the graphite particles included in the graphite composition can have a thickness of no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, no more than about 9 μm, no more than about 8 μm, no more than about 7 μm, no more than about 6 μm, no more than about 5 μm, no more than about 4.5 μm, no more than about 4 μm, no more than about 3.5 μm, no more than about 3 μm, no more than about 2.5 μm, no more than about 2 μm, no more than about 1.5 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, no more than about 20 nm, or no more than about 10 nm. Combinations of the above-referenced thickness are also possible (e.g., at least about 150 nm and no more than about 50 μm or at least about 50 nm and no more than about 500 nm), inclusive of all values and ranges therebetween. In some embodiments, the graphite particles included in the graphite composition can have a thickness dimension of about 150 nm, about 200 nm, about 300 nm, about 400 nm, about 500 nm, about 600 nm, about 700 nm, about 800 nm, about 900 nm, about 1 μm, about 1.5 μm, about 2 μm, about 2.5 μm, about 3 μm, about 3.5 μm, about 4 μm, about 4.5 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm.

In some embodiments, the micronization can include milling the graphite composition. In some embodiments, the milling can include at least one of ball milling, impact milling, high-energy mechanical milling, dry mechanical milling, or jet milling. In some embodiments, the micronization can include employing at least one of ultrasonication, chemical exfoliation, or calendering techniques, alternative to, or in combination with milling. In some embodiments, ball milling may be utilized, wherein the graphite composition is ground in the presence of grinding media within a rotating cylinder.

In some embodiments, the micronization can produce a plurality of micronized graphite particles having a particle size D50 of at least about 5 μm, at least about 5.5 μm, at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, or at least about 25 μm. In some embodiments, the micronization can produce a plurality of micronized graphite particles having a particle size D50 of no more than about 25 μm, no more than about 24 μm, no more than about 23 μm, no more than about 22 μm, no more than about 21 μm, no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9.5 μm, no more than about 9 μm, no more than about 8.5 μm, no more than about 8 μm, no more than about 7.5 μm, or no more than about 7 μm. Combinations of the above-referenced particle size ranges are also possible (e.g., at least about 5 μm and no more than about 25 μm, or at least about 6 μm and no more than about 23 μm). In some embodiments, the micronization can produce a plurality of micronized graphite particles having a particle size D50 of about 5 μm, about 5.5 μm, about 6 μm, about 6.5 μm, about 7 μm, about 7.5 μm, about 8 μm, about 8.5 μm, about 9 μm, about 9.5 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, or about 25 μm.

In some embodiments, the micronization can produce fine graphite particles with a D50 particle size of no more than about 4 μm, 3 μm, 2 μm, or 1 μm as a byproduct. Additionally, the byproduct of micronization can make up no more than about 20 wt%, 15 wt%, 10 wt%, 5 wt%, 3 wt%, or 1 wt% of the total graphite particles undergoing the micronization at step 11.

At step 12, the spheronization process (also referred to as “the spheronization”) can generate rounded, granular graphite particles from the graphite composition or from the plurality of micronized graphite particles obtained from step 11. The formation of spherical graphite particles can enhance the performance of graphite in lithium-ion battery anodes compared to non-spherical graphite flakes. Spherical particles can improve packing density, which allows for a more uniform and compact electrode structure. This reduces the void spaces within the anode material, leading to improved electrical conductivity and more efficient ion transport. Furthermore, the spherical shape results in a lower surface area, which helps achieve longer cycle life and greater stability in battery applications compared to flake-shaped graphite. As a result, spherical graphite particles can provide better capacity retention, cycling stability, and overall battery performance compared to the irregular shape of graphite flakes, which typically create more voids and uneven packing in the anode. In some embodiments, the plurality of spherical graphite particles can have a particle size D50 ranging from about 5 μm to about 25 μm.

In some embodiments, the spherical graphite particles can have a sphericity at least about 0.7, at least about 0.75, at least about 0.8, at least about 0.85, at least about 0.9, at least about 0.91, at least about 0.92, at least about 0.93, at least about 0.94, at least about 0.95, at least about 0.96, at least about 0.97, at least about 0.98, at least about 0.99, at least about 0.991, at least about 0.992, at least about 0.993, at least about 0.994, at least about 0.995, at least about 0.996, at least about 0.997, at least about 0.998, or at least about 0.999.

In some embodiments, the spheronization can include mechanical milling. In some embodiments, the spheronization can include mechanical milling techniques, such as high-speed rotary milling, to round the edges of the graphite particles, thereby creating a spherical morphology. In some embodiments, the spheronization may result in the collection of multiple streams of spherical graphite, each characterized by distinct particle size distributions. That is, in some embodiments, the plurality of spherical graphite particles has a multi-modal particle size distribution. In some embodiments, multi-modal spherical graphite particles can have a particle size D50 ranging from μm5 μm to about 25 μm, with each particle size distribution falling within this range. For instance, the spheronization can yield a plurality of spherical graphite particles with D50 values of at least two of about 8 μm, about 11 μm, about 15 μm, and about 18 μm. Each particle size distribution can be tailored to optimize the performance of the graphite for specific applications. This multi-modal particle size distribution allows for customization of the spherical graphite particles to meet specific application requirements. Without being bound by a theory, multi-modal particle size distribution can enhance packing density and/or mechanical stability of an anode. For example, smaller particles may fill voids between larger particles, reducing porosity and improving conductivity.

In some embodiments, the plurality of spherical graphite particles can have a particle size D50 of at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, or at least about 25 μm. In some embodiments, the plurality of spherical graphite particles can have a particle size D50 of no more than about 25 μm, no more than about 24 μm, no more than about 23 μm, no more than about 22 μm, no more than about 21 μm, no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, or no more than about 6 μm. Combinations of the above-referenced particle size ranges are also possible (e.g., at least about 5 μm and no more than about 25 μm, or at least about 6 μm and no more than about 23 μm). In some embodiments, the plurality of spherical graphite particles can have a particle size D50 of about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, or about 25 μm.

In some embodiments, the spheronization can include agglomerating the plurality of graphite particles or the plurality of micronized graphite particles under controlled conditions to form spherical graphite in a form of spherical agglomerates. In some embodiments, the spheronization may include mechanical rounding techniques to enhance the sphericity and uniformity of the graphite particles. This mechanical rounding process can improve the spherical morphology, resulting in consistent particle sizes (e.g., narrow particle size distribution with PDI of 0.3 or less) and shapes, which can be desired for some of the high-density anode applications.

Step 12 can be performed through either a batch method or a cascade method, with the latter involving multiple mills to achieve the desired particle roundness and size distribution. The cascade method is particularly effective in producing spherical graphite with highly uniform particle shapes across various size distributions. In some embodiments, the cascade method involves sequential milling stages, each optimized for obtaining desired particle size ranges.

Spheronization of graphite generates round, granular particles; however, some of these particles are too small (e.g., having an average particle size of less than 5 μm) to be used as anode material, as they do not meet the strict surface area and tap density requirements of the electrode production industry. That is, in some embodiments, some of the graphite particles are fully rounded but are too small to make an acceptable anode particle. During the transformation from flake-shaped graphite to spherical graphite, certain particles break or fail to achieve the required size, rendering them unsuitable for anode applications. These particles, typically less valuable than spherical graphite, are often repurposed as carburizers in steel and cast-iron manufacturing. Efficient utilization of these by-products contributes to waste reduction and enhances the overall sustainability of the graphite production process. In various embodiments, these graphite particles may be used as feedstock for producing graphene particles, for instance, through exfoliation techniques.

In some embodiments, the graphite particles produced by the spheronization can have average dimensions between about 5 μm and about 10 μm. In some embodiments, the graphite particles may exhibit a multimodal distribution, where each distinct distribution can independently have average particle dimensions ranging from approximately 5 μm to 10 μm, less than 5 μm, or greater than 10 μm. These varying particle sizes can be further processed to produce graphene of different sizes, tailored for specific applications, ensuring optimal performance based on the required properties of the final product.

In some embodiments, some of the graphite particles can have an edge-trimmed flake shape. In some embodiments, some of the graphite particles can have a shape of cuboids with rounded corners. In some embodiments, some of the graphite particles can be incompletely rounded. In some embodiments, the graphite particles can have a sphericity of at least about 0.7, at least about 0.75, at least about 0.8, at least about 0.85, at least about 0.9, at least about 0.91, at least about 0.92, at least about 0.93, at least about 0.94, at least about 0.95, at least about 0.96, at least about 0.97, at least about 0.98, at least about 0.99, at least about 0.991, at least about 0.992, at least about 0.993, at least about 0.994, at least about 0.995, at least about 0.996, at least about 0.997, at least about 0.998, or at least about 0.999. In some embodiments, the graphite particles can have a sphericity of no more than about 1, no more than about 0.999, no more than about 0.998, no more than about 0.997, no more than about 0.996, no more than about 0.995, no more than about 0.994, no more than about 0.993, no more than about 0.992, no more than about 0.991, no more than about 0.99, no more than about 0.98, no more than about 0.97, no more than about 0.96, no more than about 0.95, no more than about 0.94, no more than about 0.93, no more than about 0.92, no more than about 0.91, no more than about 0.9, no more than about 0.85, no more than about 0.8, or no more than about 0.75. Combinations of the above-referenced sphericities of the graphite particles are also possible (e.g., at least about 0.7 and no more than about 1 or at least about 0.95 and no more than about 0.995), inclusive of all values and ranges therebetween. In some embodiments, the graphite particles can have a sphericity of about 0.7, about 0.75, about 0.8, about 0.85, about 0.9, about 0.91, about 0.92, about 0.93, about 0.94, about 0.95, about 0.96, about 0.97, about 0.98, about 0.99, about 0.991, about 0.992, about 0.993, about 0.994, about 0.995, about 0.996, about 0.997, about 0.998, about 0.999, or about 1.

In some embodiments, the graphite particles obtained from the spheronization process can be reprocessed or repurposed in subsequent steps, ensuring that all material streams are efficiently utilized. This approach can enhance overall efficiency in the production of high-performance spherical graphite anodes for lithium-ion batteries.

After the completion of spheronization at step 12, at least two different streams of graphite (i.e., spherical graphite particles and graphite particles) can be generated.

At step 13, the plurality of spherical graphite particles obtained through the spheronization process are separated from the plurality of graphite particles rejected from the spheronization process. The plurality of graphite particles rejected from the spheronization process, sometimes referred to as the “rejected graphite particles,” or “reject stream graphite” is a by-product of the spheronization process.

In some embodiments, the separation of spherical graphite particles from the rejected graphite stream is performed via an application of aerodynamic forces to create distinct particle trajectories based on parameters such as size, shape, and density. In some embodiments, the separation process at step 13 includes feeding the plurality of spherical graphite particles and the rejected graphite particles into an airstream. The airstream is configured to generate at least two different particle trajectories to separate the spherical graphite particles from the rejected graphite particles based on at least one of their size, shape, or density. In some embodiments, the airstream is configured to separate spherical graphite particles from rejected graphite particles by exploiting the differences in their aerodynamic properties, such as drag and inertia, which cause particles of different sizes and shapes to behave differently under the same airflow conditions.

A flow rate of the airstream plays a role in this separation process, which influences how particles are carried through the airstream. Increased airflow tends to carry finer particles out of the airstream, while reduced airflow allows heavier particles to remain. For example, in one embodiment, the flow rate of the airstream is approximately 3,750 m³/hr for a material throughput of 2,000 kg/hr. If there is a need to adjust the fineness specifications of graphite particles, such adjustments can be made by modifying the flow rate of the airstream.

In some embodiments, the separation can be achieved by using a classifier that introduces the spherical graphite particles and the rejected graphite particles into an airstream. The classifier operates such that heavier spherical graphite particles, having a greater mass, are less influenced by the airflow and settle in a distinct trajectory, while lighter or finer particles, which can constitute the rejected graphite stream, are carried away by the airstream due to their smaller size or lower density. The classifier system can be further adjusted through various operational parameters. For example, in some embodiments, the rotational speed of a classifier wheel can be adjusted, where a higher rotational speed applies greater centrifugal forces, resulting in finer particle separation. Conversely, a lower speed can result in coarser separation of the particles. Additionally, in some embodiments, the flow rate of the airstream can be adjusted to influence the separation, wherein increasing the volume and velocity of the airflow can lead to the removal of finer particles from the stream, while reducing airflow enables heavier particles to remain.

In some embodiments, the feed rate of the spherical graphite particles and the rejected graphite particles can also be adjusted to improve separation efficiency. A lower feed rate often results in more effective classification, as particles are given more time to be separated by the air stream. For instance, the spherical graphite output rate could range from 300 to 1,200 kg/hr when using equipment capable of feeding up to 2,000 kg/hr of total graphite, with the remaining particles being rejected depending on the feed rate of the classifier. By adjusting the feed rate, the classification process can be fine-tuned to achieve the desired separation efficiency.

Accordingly, in some embodiments, the separation process may involve feeding the plurality of spherical graphite particles and the rejected graphite particles into an airstream at a feed rate ranging from 500 to 1,100 kg/hr of total material.

At step 14, a plurality of spherical graphite particles is collected in a first collection zone, and a plurality of graphite particles that do not meet the spheronization criteria is collected in a second collection zone, distinct from the first collection zone. In some embodiments, the second collection zone may include more than one zone, with each zone positioned at separate locations, where the ejected graphite particles are separated based on specific characteristics such as particle size or morphology. In some embodiments, the first collection zone may include more than one zone, with each zone positioned at separate locations, where the spherical graphite particles are separated based on specific characteristics such as particle size or morphology. Each zone is configured to hold or house the graphite particles. The zones may include a container, a tank, other suitable collection means, or can be a part of a classifier. A classifier may be employed to direct the spherical particles and/or the rejected graphite particles to the appropriate zone.

A ratio of spherical graphite particles collected in the first collection zone to a total of both the spherical graphite particles and the rejected graphite particles from the spheronization process collected in the second collection zone can vary depending on the specific process parameters. This ratio typically ranges from about 20% to about 70% by weight, with lower ratios (e.g., 20% to 30%) indicating processes where a higher proportion of material is rejected, and higher ratios (e.g., 60% to 70%) reflecting more efficient spheronization with minimal waste. Adjusting variables such as airflow rate, particle size, and processing conditions allows fine-tuning of this ratio, optimizing the yield of spherical graphite relative to rejected material for specific production requirements.

The method 10 further includes processing the plurality of spherical graphite particles collected in the first collection zone to form an anode-active material. In some embodiments of method 10, one or more magnetic separator(s) can be employed at various stages to remove magnetic impurities. On or more purification step(s) can be conducted either before or after step 12, the spheronization of graphite. In some embodiments, the magnetic separators may be employed to remove ferromagnetic impurities introduced during milling and/or classification. These impurities, if not removed, can interfere with battery performance by affecting conductivity and/or causing localized heating during cycling.

At step 15, the method 10 may include subjecting the rejected graphite particles collected in the second collection zone to a graphene production process, wherein any graphene (or graphene oxide) production method based on graphite exfoliation may be employed. Suitable exfoliation methods include, but are not limited to, liquid phase exfoliation, dry exfoliation, chemical exfoliation, mechanochemical exfoliation, and electrochemical exfoliation.

In some embodiments, the ejected graphite particles may be treated with chemicals and/or surfactants to enhance the efficiency of exfoliation. In other embodiments, the exfoliation may include milling the ejected graphite particles such as dry mechanical milling.

As used herein, the term “milling” refers to the process of breaking down a solid material into particles of a desired size. In some embodiments, milling includes grinding by compression, friction, or a combination of both. The milling process may include the use of various mills to achieve the desired particle size and characteristics. In some embodiments, milling can result in exfoliation of graphite particles (e.g., the graphite composition, the ejected graphite particles).

In some embodiments, the milling process may include using at least one of a jet mill, a hammer mill, a shearing mill, a roller mill, a shock shearing mill, a ball mill, an attritor (also referred to as a stirred ball mill), or a tumbling mill. These mills can be employed to grind and shear the ejected graphite particles during the exfoliation.

In some embodiments, ball milling may be carried out in any suitable grinding mill system that comprises a mill jar and facilitates the shearing and exfoliation of the ejected graphite particles into thinned graphite. Examples of grinding mill systems that may be used for ball milling include, but are not limited to, ball mills, rod mills, pebble mills, autogenous mills, semi-autogenous mills, roller mills (e.g., jar roller mills, ring mills, frictional-ball mills), attritors, planetary mills, jet mills, aerodynamic mills, shear mixers, and other comparable systems.

In some embodiments, the step 15 may include thinning the rejected graphite particles to reduce its lateral size. Specifically, as graphene layers are exfoliated from the rejected graphite particles, the in-plane dimensions of the thinned product may also decrease. This thinning process can yield smaller, more manageable graphene flakes for further processing or application.

In some embodiments, the exfoliation may include multiple exfoliation steps to improve the quality and consistency of the resulting graphene particles. The exfoliated graphite may undergo functionalization, where chemical groups are introduced to improve the solubility and dispersibility of graphene in various polymers, resins, or liquids. In some embodiments, graphene functionalization may include injecting reactive gases into the exfoliation chamber. In other embodiments, the exfoliation process may be carried out at elevated temperatures to enhance yield and reduce processing time. For example, graphite may be exfoliated through thermal shock, induced by rapid heating or cooling, to facilitate separation of graphene layers.

In some embodiments, the exfoliated graphene particles may be subjected to a purification process (e.g., chemical, mechanical sieving, or magnetic separation) to remove impurities introduced during exfoliation. The exfoliated graphene may also be separated from unexfoliated graphite through a suitable separation technique. In some embodiments, the rejected graphite particles can undergo a purification process prior to the exfoliation process.

In some embodiments, exfoliation of the rejected graphite particles may ultimately result in the production of various types of graphene, including pristine graphene, oxidized graphene, functionalized graphene, or reduced graphene oxide. In some embodiments, the rejected graphite particles may be classified based on their morphology prior to exfoliation. Morphological categories may include edge-trimmed flakes, cuboids with rounded corners, incompletely rounded particles, and fully rounded particles below a critical size threshold. Each category may be subjected to a tailored exfoliation protocol optimized for its structural characteristics. For example, edge-trimmed flakes may undergo liquid-phase exfoliation with surfactant-assisted dispersion, while cuboidal particles may be subjected to at least one of thermal shock or dry exfoliation. Following exfoliation, the resulting graphene particles may be functionalized with chemical groups such as hydroxyl, carboxyl, or amine groups, selected based on the intended application of the graphene (e.g., conductive additives, coatings, or composites). This morphology-based approach can enhance exfoliation yield and enable the production of application-specific graphene materials.

In some embodiments, the graphene produced may exhibit a surface area ranging from 300 m²/g to 750 m²/g, as measured by the Brunauer-Emmett-Teller (BET) method. The specific surface area achieved depends on the exfoliation process and the conditions applied. In some embodiments, the graphene obtained by method 10 according to multiple embodiments described herein, can have a surface area of at least about 300 m²/g BET (Brunnauer-Emmett-Teller), at least about 310 m²/g BET, at least about 320 m²/g BET, at least about 330 m²/g BET, at least about 340 m²/g BET, at least about 350 m²/g BET, at least about 360 m²/g BET,, at least about 370 m²/g BET, at least about 380 m²/g BET, at least about 390 m²/g BET, at least about 400 m²/g BET, at least about 410 m²/g BET, at least about 420 m²/g BET, at least about 430 m²/g BET, at least about 440 m²/g BET, at least about 450 m²/g BET, at least about 460 m²/g BET, at least about 470 m²/g BET, at least about 480 m²/g BET, at least about 490 m²/g BET, at least about 500 m²/g BET, at least about 510 m²/g BET, at least about 520 m²/g BET, at least about 530 m²/g BET, at least about 540 m²/g BET, at least about 550 m²/g BET, at least about 560 m²/g BET, at least about 570 m²/g BET, at least about 580 m²/g BET, at least about 590 m²/g BET, at least about 600 m²/g BET, at least about 610 m²/g BET, at least about 620 m²/g BET, at least about 630 m²/g BET, at least about 640 m²/g BET, at least about 650 m²/g BET, at least about 660 m²/g BET, at least about 670 m²/g BET, at least about 680 m²/g BET, at least about 690 m²/g BET, at least about 700 m²/g BET, at least about 710 m²/g BET, at least about 720 m²/g BET, at least about 730 m²/g BET, at least about 740 m²/g BET, or at least about 750 m²/g BET.

In some embodiments, graphene particles or flakes obtained by method 10 can have any of the properties of the graphene flakes described in U.S. Pat. No. 9,469,542 (“the '542 patent”), filed Dec. 22, 2015, and titled, “Large Scale Production of Thinned Graphite, Graphene, and Graphite-Graphene Composites,” the entire disclosure of which is hereby incorporate by reference and attached hereto as Exhibit A.

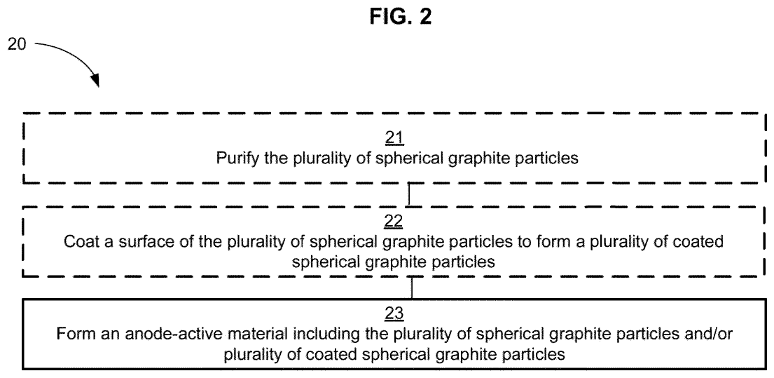

FIG. 2 is a flow diagram of a method 20 for post-processing a plurality of spherical graphite particles obtained by method 10, according to multiple embodiments described herein.

The method 20 can include optionally purifying the plurality of spherical graphite particles, at step 21, and optionally coating a surface of the plurality of spherical graphite particles at step 22. The method 20 includes forming an anode-active material including the plurality of spherical particles and/or plurality of coated spherical particles.

At step 21, purifying the spherical graphite particles can include at least one of a chemical treatment, a physical treatment, or a thermal treatment. Purification can remove impurities that can negatively impact the performance of graphite anodes in lithium-ion batteries and other electrochemical devices. Impurities such as metal ions, non-carbon elements, and volatile compounds can lead to undesirable side reactions, reduced electrical conductivity, and diminished structural integrity of the anode material.

In some embodiments, purifying can include chemical purification, where the spherical graphite particles are treated with strong acids or bases to remove metal impurities. In some embodiments, purifying can include acid leaching, where the spherical graphite particles are treated with strong acids to dissolve and eliminate metal impurities. Acid leaching may involve a treatment duration ranging from 1 hour to several hours, depending on the concentration of the acid and the extent of impurities present in the graphite. The strong acids can include at least one of hydrochloric acid (HCl), sulfuric acid (H₂SO₄), or nitric acid (HNO₃). For example, a treatment involving hydrochloric acid at concentrations ranging from 1 M to 10 M can dissolve and eliminate metal impurities such as iron, copper, and other transition metals. The treatment can be performed at room temperature or elevated temperatures, where the elevated temperature can be between 50° C. to 100° C. to enhance the solubility of the metal ions and accelerate the removal process.

In some embodiments, purifying can include thermal purification, where the spherical graphite particles are heated to high temperatures to volatilize and remove impurities. The elevated temperature can be between 500° C. and 1000° C., with specific temperatures chosen based on the nature of the impurities being targeted for removal. For instance, volatile organic compounds can be effectively removed at temperatures around 700° C., ensuring that the graphite structure remains intact while enhancing its purity.

In some embodiments, purifying can include flotation purification, wherein the graphite is mixed with water and surfactants to separate impurities based on differences in surface properties. The surfactants can include cationic, anionic, or nonionic surfactants, which facilitate the separation of hydrophobic graphite particles from hydrophilic impurities.

In some embodiments, purifying can include using magnetic separation to remove ferromagnetic impurities from the spherical graphite particles. This method can be particularly effective for removing impurities such as iron filings or other ferromagnetic particles that may have been introduced during the grinding process.

In some embodiments, purifying can include sublimation, where the graphite is heated in a vacuum to sublimate and separate volatile impurities from the purified graphite. Sublimation may be performed at temperatures ranging from 500° C. to 800° C. under vacuum conditions to enhance the removal efficiency of volatile contaminants.

In some embodiments, purifying can include electrochemical purification, where an electrical current is applied to the graphite in an electrolyte solution to dissolve and remove impurities. The electrolyte solution can include various salts such as sodium sulfate (Na₂SO₄) or potassium hydroxide (KOH), and the electrochemical process may be conducted at temperatures ranging from room temperature to elevated temperatures of 60° C. to 80° C. to improve the dissolution rates of the impurities.

In some embodiments, purifying can include solvent extraction, where organic solvents such as ethanol, acetone, or dichloromethane are used to selectively dissolve and remove specific impurities from the graphite. The extraction process can involve mixing the graphite with the solvent for a specified duration, typically ranging from 30 minutes to several hours, to ensure effective removal of the impurities.

In some embodiments, purifying can include using high-intensity ultrasonic waves to break up and disperse impurities, facilitating their removal from the graphite. Ultrasonic treatment can involve frequencies ranging from 20 kHz to 40 kHz, which enhances the dispersion of the graphite particles and the separation of impurities through cavitation effects.

In some embodiments, purifying can include the application of a combination of mechanical and chemical treatments to achieve high-purity graphite (e.g., 99% or more). These methods can be synergistically combined to optimize the removal of a broad range of impurities while maintaining the structural integrity of the graphite. Each of these purification methods ensures a significant improvement in the purity of the graphite, which leads to more consistent and reliable performance in graphite anode applications. Enhanced purity contributes to improved capacity, efficiency, and cycle life in batteries and other electrochemical devices, ensuring the purified graphite provides superior performance in high-performance applications.

The purification of graphite to achieve ultra-high purity levels, typically greater than 99.95%, can be performed using chemical methods, thermal methods, or a combination thereof. In some embodiments, caustic baking followed by acid leaching is used to effectively remove impurities. In some embodiments, hydrofluoric acid (HF) is employed to dissolve silicate-based contaminants. Alternatively, in other embodiments, hydrochloric acid, sulfuric acid, nitric acid, or combinations of these acids are used to target and eliminate impurities.

Thermal purification may also be utilized, with the optional injection of gases such as chlorine to enhance purification efficiency and reduce the operating temperature. In some embodiments, thermal purification is conducted at temperatures ranging from approximately 2,000° C. to 2,500° C., yielding graphite with purity levels between 99.5% and 99.9%. In other embodiments, higher temperatures in the range of 2,500° C. to 3,000° C. are used, achieving purities from 99.9% to 99.999%. The flexibility provided by combining chemical and thermal methods allows for the optimization of processes based on the target purity, impurity profile, and end-use requirements, achieving levels exceeding 99.95% as needed.

In step 22, in some embodiments, the method can include coating the surface of a plurality of spherical graphite particles with a carbon-containing composition. In some embodiments, only a portion of the spherical graphite particles may be coated, depending on the desired electrochemical performance or application-specific requirements. The method 20 further comprises applying a heat treatment to the coated spherical graphite particles.

The carbon coating process can result in the formation of an amorphous carbon layer on the surface of the spherical graphite particles, which can contribute to improved electrochemical performance, including enhanced rate capability and extended cycle life in batteries. The coated spherical graphite particles may also be utilized in other electrochemical devices and applications that require high-performance anode materials.

In some embodiments, the carbon coating process can be carried out under inert gas atmospheres, such as nitrogen or argon, to prevent oxidation and ensure the uniform formation of the amorphous carbon layer. The carbon coating process can be performed using various furnaces, such as a rotary furnace, RHK furnace, or pusher furnace, where temperatures typically range from about 700° C. to 1,200° C., depending on the desired coating thickness and material properties. In certain embodiments, the carbon coating may occur at least partially during the spheronization process.

In some embodiments, the system may include an integrated processing unit configured to perform purification and carbon coating of spherical graphite particles in a modular fashion. The processing unit may include a purification module configured to remove metallic and non-carbon impurities via chemical, thermal, or magnetic separation techniques, followed by a coating module configured to apply a carbon-containing composition (e.g., coal tar pitch, petroleum pitch, and/or the like) to the purified spherical graphite particles. The coating module may include at least one of a rotary furnace, a chemical vapor deposition (CVD) chamber, or a spray drying system, operating under inert gas conditions. In some embodiments, the system may include in-line sensors configured to monitor particle purity and coating thickness in real time, enabling dynamic adjustment of process parameters. This processing configuration can reduce contamination risk, improve throughput, and enhances the consistency of the anode-active material produced.

In some embodiments, the carbon coating can cover not only the exterior surfaces of the spherical graphite particles but may also partially or fully cover the interior surfaces. Following the carbon coating process, the spherical graphite particles may undergo a sieving or classification step to remove or break up large agglomerates, ensuring a uniform particle size distribution.

The carbon coating process may involve a variety of methods for applying a carbon layer to the spherical graphite particles. In some embodiments, the carbon coating process comprises mixing coal tar pitch or petroleum pitch with the spherical graphite particles, followed by a high-temperature carbonization process. The carbonization step, conducted at temperatures ranging from approximately 900° C. to 1,200° C., removes volatile components, resulting in the retention of a uniform amorphous carbon layer on the surface of the graphite particles.

In some embodiments, a chemical vapor deposition (CVD) process can be employed, wherein a carbon-containing gas, such as methane, ethylene, or acetylene, is introduced into a reactor. The gas decomposes at high temperatures, typically between 700° C. and 1,000° C., depositing an amorphous carbon layer on the spherical graphite particles. Alternatively, in some embodiments, physical vapor deposition (PVD) methods, such as sputtering or evaporation, are used to deposit the carbon layer. These methods may operate under controlled vacuum conditions, and the deposited carbon layer may have a thickness ranging from a few nanometers to several micrometers.

In some embodiments, the carbon coating process can include dispersing the spherical graphite particles in a solution containing a carbon precursor, followed by drying and pyrolysis to form the carbon coating. This method, known as liquid phase deposition, allows for precise control over the coating thickness and uniformity. Pyrolysis is typically conducted at temperatures ranging from 600° C. to 1,100° C., depending on the precursor material and the desired properties of the amorphous carbon layer.

In some embodiments, the spherical graphite particles can be coated with a polymer, which is subsequently carbonized through heat treatment at temperatures ranging from 800° C. to 1,200° C. to form the amorphous carbon coating. Similarly, in some embodiments, a carbon-rich resin is applied to the graphite particles, followed by heat treatment at temperatures from 700° C. to 1,100° C., converting the resin into amorphous carbon.

In some embodiments, the carbon coating process can include using carbohydrates, such as sucrose or glucose, as a precursor, which decompose into carbon upon heat treatment. The decomposition typically occurs at temperatures between 600° C. and 900° C., resulting in the formation of an amorphous carbon layer.

In some embodiments, the carbon-coated spherical graphite particles as anode materials are configured to exhibit low swelling, with maximum swelling limited to less than 25% during electrochemical cycling, thereby improving the dimensional stability and overall performance of the anode material in battery applications.

At step 23, forming an anode-active material can be performed using any known method in the art commonly employed to create an anode-active material with flake graphite. These methods may include, but are not limited to, processes such as mixing, coating, and slurry casting, wherein spherical graphite particles are incorporated in a similar manner as flake graphite. In some embodiments, a slurry including spherical graphite particles and/or carbon-coated spherical graphite particles, a binder, and optionally one or more conductive additives may be applied to a current collector using a doctor blade or slot-die coating technique. The slurry may then be dried and calendared to achieve desired electrode thickness and density.

In some embodiments, the anode-active material can have a rate performance ranging from higher than 3C up to 15C. As used herein, the “C-rate” represents the charge/discharge rate of the battery, with 1C demonstrating a full charge or discharge in one hour.

In some embodiments, forming the anode-active material may include combining processed (e.g., coated) spherical graphite particles and/or unprocessed spherical graphite particles collected from the first collection zone, allowing for tailored electrochemical properties. In some embodiments, forming the anode-active material may include mixing the spherical graphite particles and/or the coated spherical graphite particles with at least one of a conductive additive, a binder, a composition including silicon, or any material that can be used in forming anode-active materials for lithium-ion batteries. In some embodiments, the conductive additive may include materials such as carbon black, carbon nanotubes, and/or the like, which serve to enhance the overall conductivity of the anode by creating a conductive network that facilitates efficient electron flow during charging and discharging cycles. The spherical graphite particles, due to their uniform shape, contribute to increased packing density, which optimizes electrical and ionic pathways. The binder, such as polyvinylidene fluoride (PVDF), may be included to maintain the structural cohesion of the material, ensuring the graphite particles and conductive additives remain well-integrated during cycling. In some embodiments, the binder may include polymeric materials such as carboxymethyl cellulose (CMC) or styrene-butadiene rubber (SBR).

The mixing process may occur in a controlled environment to ensure the homogeneity of the slurry. In some embodiments, mixing may be performed at elevated temperatures (e.g., from 30° C. to 90° C.) to improve the dispersion of the conductive additives. Mixing can also be performed within a solvent to aid in the uniform distribution of the components. In some embodiments, the mixing environment may be maintained under inert gas conditions, such as argon or nitrogen, to prevent oxidation or contamination of the spherical graphite particles.

In some embodiments, the mixing process can form an anode-active material in the form of a slurry, which includes the spherical graphite particles and/or the coated spherical particles, along with at least one of a conductive additive or a binder. The slurry can be applied to a current collector, followed by drying to remove solvents, and compressed to form an anode material suitable for high-performance applications.

Provided herein is a system for separating a plurality of spherical graphite particles from a plurality of ejected graphite particles, according to an embodiment. In some embodiments, the system provided herein can be used for separating the plurality of spherical graphite particles obtained by method 10 from the plurality of ejected graphite particles obtained by method 10, according to an embodiment.

In some embodiments, the system can include a classifier configured to feed a plurality of spherical graphite particles and a plurality of graphite particles rejected from a spheronization process into an airstream. The airstream is configured to create at least two different particle trajectories based on at least one of their particle size, shape, or density. These trajectories can allow for the separation of the spherical graphite particles from the rejected graphite particles. The system further includes a first collection zone, configured to receive the separated spherical graphite particles, and a second collection zone, configured to receive the graphite particles rejected from the spheronization process, wherein the second collection zone is different from the first zone.

In some embodiments, the system can further include one or more collection zone(s) configured to receive a plurality of spherical graphite particles having a different particle size D50 than particle size D50 of the plurality of spherical graphite particles received in the first collection zone. In some embodiments.

In some embodiments, the classifier is further configured to include a classifier rotor with adjustable rotational speed. The rotational speed of the classifier wheel directly influences the centrifugal force exerted on the particles, affecting the fineness of separation. In some embodiments, the classifier wheel may operate at adjustable speeds ranging from 4,000 to 6,000 rpm. Higher rotational speeds can enhance separation precision by increasing centrifugal force, allowing finer particles to be separated more effectively. A higher classifier wheel speed, such as 4,600-6,000 rpm, may allow for finer particle separation, while a lower speed may result in coarser particle size distribution. For example, operating the classifier wheel at 4,600 rpm can result in a product fineness with a D97 of 25-40 microns. The classifier may include a motor with a capacity of 15 kW, suitable for processing a total throughput of 2,000 kg/hr, with a fineness range of D97 =5-50 microns.

In some embodiments, an airflow rate of the airstream through the classifier is adjustable to optimize particle separation. The airflow rate, such as 3,750 m³/hr for a 2,000 kg/hr material throughput, controls how particles are carried through the system. Increased airflow tends to remove finer particles, while reduced airflow allows coarser particles to remain in the classification zone.

In some embodiments, the airstream has a flow rate of at least about 1,500 m³/hour, at least about 1,700 m³/hour, at least about 1,900 m³/hour, at least about 2,100 m³/hour, at least about 2,300 m³/hour, at least about 2,500 m³/hour, at least about 2,700 m³/hour, at least about 2,900 m³/hour, at least about 3,100 m³/hour, at least about 3,300 m³/hour, or at least about 3,500 m³/hour, for processing a total of about 2,000 kg of the plurality of spherical graphite particles and the plurality of graphite particles rejected from the spheronization process per hour. In some embodiments, the airstream has a flow rate of no more than about 4,000 m³/hour, no more than about 3,800 m³/hour, no more than about 3,600 m³/hour, no more than about 3,400 m³/hour, no more than about 3,200 m³/hour, no more than about 3,000 m³/hour, no more than about 2,800 m³/hour, no more than about 2,600 m³/hour, no more than about 2,400 m³/hour, no more than about 2,200 m³/hour, or no more than about 2,000 m³/hour, for processing a total of about 2,000 kg of the plurality of spherical graphite particles and the plurality of graphite particles rejected from the spheronization process per hour. Combinations of the above-referenced flow rates are also possible (e.g., at least about 1,500 m³/hour and no more than about 4,000 m³/hour or at least about 1,500 m³/hour (equivalent to about 880 cubic feet per minute (CFM)) and no more than about 2,400 m³/hour (equivalent to about 1500 CFM), inclusive of all values and ranges therebetween. In some embodiments, the airstream has a flow rate of about 1,500 m³/hour, about 1,700 m³/hour, about 1,900 m³/hour, about 2,100 m³/hour, about 2,300 m³/hour, about 2,500 m³/hour, about 2,700 m³/hour, about 2,900 m³/hour, about 3,100 m³/hour, about 3,300 m³/hour, about 3,500 m³/hour, about 3,800 m³/hour, or about 4,000 m³/hour, for processing a total of about 2,000 kg of the plurality of spherical graphite particles and the plurality of graphite particles rejected from the spheronization process per hour.

The airflow can be managed by a fan (e.g., an induced draft fan), which moves the material to the classification area at high speed. Under the influence of the fan, the coarse and fine materials are separated by the centrifugal force generated by the rotating classification wheel within the classifier. In some embodiments, the fan is configured to generate an airstream having a pressure ranging from about 8 kPa to about 12 kPa, and an airflow volume ranging from about 30 m³/min to about 50 m³/min. In one embodiment, the fan generates an airstream having a pressure of about 10 kPa and an airflow volume of about 40 m³/min.

The design of the classifier can enable fine particles that meet the required size specifications to be collected in downstream components such as a cyclone separator or dust collector. Meanwhile, coarser particles that do not meet the size specifications can be discharged through a lower outlet and removed from the system.

In some embodiments, the system includes a control mechanism configured to adjust a flow rate of the airstream by modifying at least one of the velocity or volume of airflow. The control mechanism may include automated dampers, variable-speed fans, or programmable logic controllers (PLCs) that regulate airflow parameters in real time to achieve desired particle separation based on size or density. The system may also include adjustable dampers or valves to fine-tune the airflow within the classification area. In some embodiments, the position of the dampers or valves can be modified to control airflow paths and adjust the pressure drop within the system. This adjustment allows for more precise classification of particles by controlling the interaction between centrifugal force and air drag. The system may use an automated damper to regulate the volume of air entering the system, thus affecting the air-to-solid ratio. By adjusting the speed of the classifier wheel and the opening of the main air valve, a balanced gas-solid two-phase flow can be created, allowing for precise classification.

In some embodiments, the classifier may further include secondary air injection to refine particle separation. Secondary air streams can be introduced in some classification systems to provide additional control over particle trajectories, improving precision in separating finer particles from coarser ones. The rotor or wheel design can also influence particle classification; turbo classifiers with turbulent airflow, for instance, allow for high-yield classification with lower energy consumption. The rotor, often cage-shaped, uses blades with gaps ranging from 1-4 mm, enabling the rejection of coarser particles while allowing finer particles to pass through.

In some embodiments, the system may further include a secondary cyclone separator configured to refine the separation of graphite particles based on aerodynamic properties. The secondary cyclone separator can be positioned downstream of the primary classifier and configured to receive airstreams containing fine graphite particles. The separator may utilize centrifugal forces to further isolate particles below a threshold particle size (e.g., less than 5 μm), which are suitable for exfoliation into graphene.

In some embodiments, the system may include a multi-stage classification apparatus including a series of classifiers arranged in cascade, each configured to separate graphite particles based on progressively narrower particle size distributions. This multi-stage configuration can allow for enhanced control over the morphology and/or size of spherical graphite particles and rejected graphite particles, thereby improving the efficiency of downstream processing steps such as exfoliation and coating.

In some embodiments, the system further includes a feed mechanism configured to deliver the plurality of spherical graphite particles and the plurality of graphite particles rejected from the spheronization process into the classifier. The feed mechanism may include a variable-speed conveyor, screw feeder, or vibratory feeder, and is configured to regulate the feed rate of the particles to obtain desired classification efficiency. The feed rate may be adjusted based on desired throughput or particle separation precision. The system may also be configured with an adjustable feed rate. The rate at which spherical graphite and rejected particles are fed into the system can affect the overall efficiency of the classification process. In some embodiments, a lower feed rate, such as 500-1100 kg/hr for a system with a capacity of 2,000 kg/hr, allows for more effective classification, as the particles have more time to be separated by the airstream and centrifugal forces.

An alternative to, or in combination with, the classifier, the system may include any suitable apparatus employed in the industry (e.g., centrifuge separators such as a hydrocyclone, gravity separators) configured to separate particles in the micron and/or nanoscale range based on at least one of their size, shape, and density.

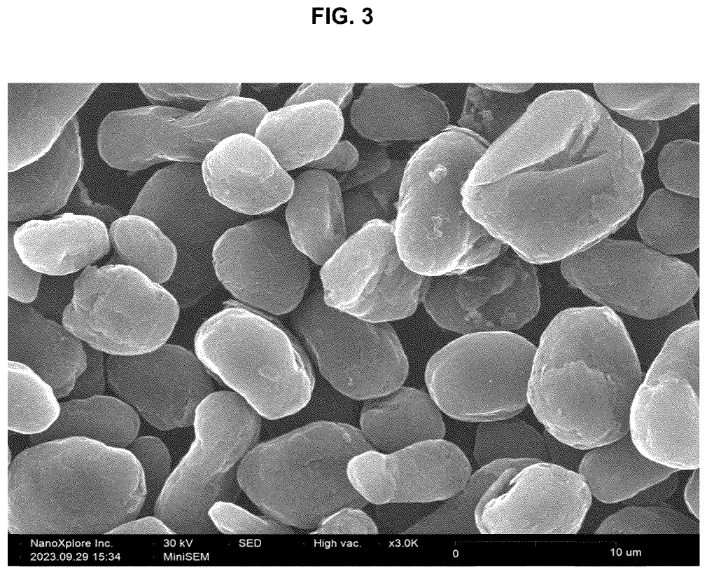

FIG. 3 is a SEM image of spherical graphite particles obtained using the method described in method 10, with the application of at least one of steps 21 or 22 from method 20, according to an embodiment. The particles range in diameter from approximately 0.5 μm to 5 μm, with sphericity values between 0.8 and 1.0, where 1.0 represents a perfect sphere. These spherical graphite particles may undergo further processing for use in anode-active materials.

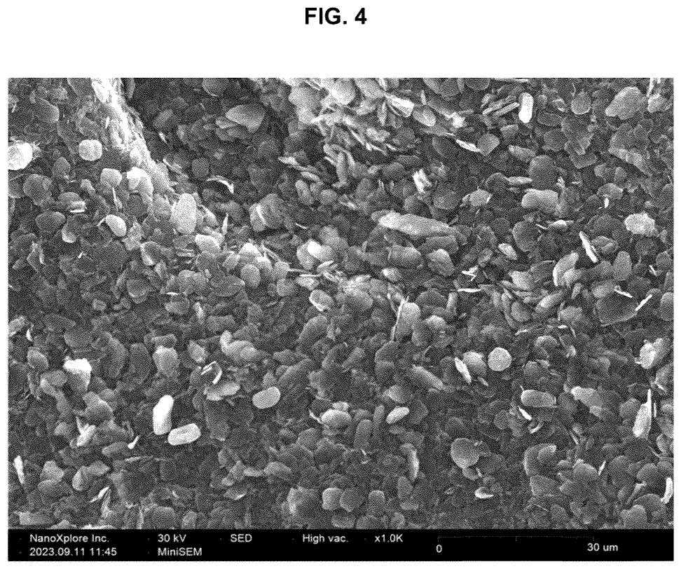

FIG. 4 is a SEM image of rejected graphite particles obtained using method 10, according to an embodiment. These particles are irregularly shaped, lacking the uniformity and sphericity seen in the spherical graphite particles of FIG. 3. Instead, they appear more angular and fragmented. The rejected particles range in size, measured as the maximum distance across the particle, from approximately 1 μm to 30 μm, showing significant size variation compared to the more uniform spherical graphite particles in FIG. 3.

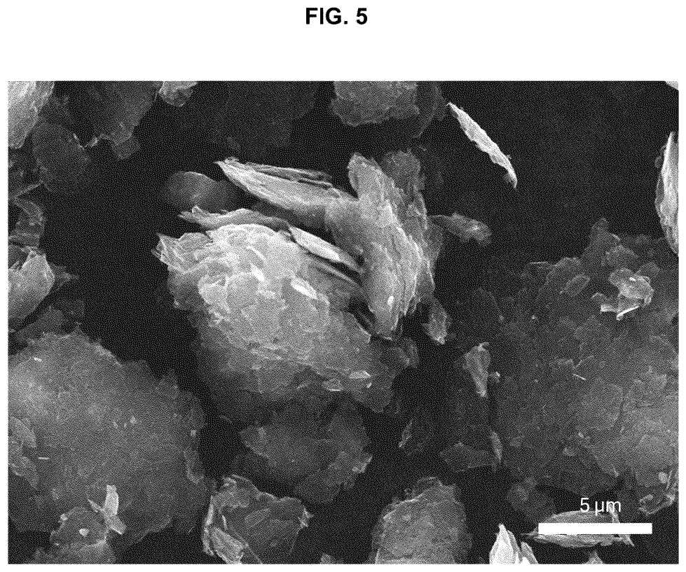

FIG. 5 is an SEM image showing exfoliated graphene flakes obtained from an ejected stream using method 10, according to an embodiment. These flakes have thin, layered structures with irregular shapes and textures. Their widths typically range from approximately 0.5 μm to 5 μm. The morphology of these flakes is characteristic of exfoliated graphene, which is known for its high electrical conductivity and mechanical strength.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process, when possible, as well as performed sequentially as described above. The embodiments have been particularly shown and described, but it will be understood that various changes in form and details may be made.

1. A method comprising:
subjecting a graphite composition to a spheronization process to produce a plurality of spherical graphite particles and a plurality of graphite particles;
separating the plurality of spherical graphite particles from the plurality of graphite particles, the plurality of graphite particles rejected from the spheronization process;
collecting the plurality of spherical graphite particles in a first collection zone, and collecting the plurality of graphite particles in a second collection zone, the second collection zone different from the first collection zone; and
exfoliating the plurality of graphite particles collected in the second collection zone to produce a plurality of graphene particles.

2. The method of claim 1, further comprising:
reducing an average particle size of the graphite composition via a micronization process prior to subjecting the graphite composition to the spheronization process.

3. The method of claim 2, wherein the micronization process comprises milling the graphite composition.

4. The method of claim 3, wherein milling comprises at least one of ball milling, impact milling, high-energy mechanical milling, dry mechanical milling, or jet milling.

5. The method of claim 1, further comprising:
purifying the plurality of spherical graphite particles after collecting the plurality of spherical graphite particles in the first collection zone.

6. The method of claim 5, wherein purifying comprises employing at least one of chemical treatment, physical treatment, or thermal treatment methods.

7. The method of claim 1, further comprising:
coating a surface of at least a portion of the plurality of spherical graphite particles with a carbon-containing composition to form a plurality of coated spherical graphite particles.

8. The method of claim 7, further comprising:
applying a heat treatment to the plurality of coated spherical graphite particles.

9. The method of claim 1, further comprising:
processing at least a portion of the plurality of spherical graphite particles collected in the first collection zone to form an anode-active material.

10. The method of claim 9, wherein the anode-active material comprises at least one of a plurality of processed spherical graphite particles and a plurality of unprocessed spherical graphite particles collected in the first collection zone.

11. The method of claim 9, wherein the processing includes processing all of the plurality of spherical graphite particles collected in the first collection zone.

12. The method of claim 1, wherein a ratio of the plurality of spherical graphite particles collected in the first collection zone to a total of both the plurality of spherical graphite particles collected in the first collection zone and the plurality of graphite particles rejected from the spheronization process collected in the second collection zone ranges from about 20% to about 70% by weight.

13. The method of claim 1, wherein separating comprises feeding the plurality of spherical graphite particles and the plurality of graphite particles into an airstream, the airstream configured to create at least two different particle trajectories to separate the plurality of spherical graphite particles and the plurality of graphite particles rejected from the spheronization process based on at least one of their size, shape, or density.

14. The method of claim 13, further comprising:
adjusting a flow rate of the airstream to control the separation of the plurality of spherical graphite particles from the plurality of graphite particles rejected from the spheronization process.

15. The method of claim 1, wherein the spheronization process comprises mechanical milling.

16. The method of claim 1, wherein the plurality of spherical graphite particles collected in the first collection zone has a particle size D50 ranging from about 5 μm and about 25 μm.

17. The method of claim 1, wherein the plurality of spherical graphite particles has a multi-modal particle size distribution.

18. The method of claim 1, wherein the graphite composition has a purity level of about 99.9% or more by weight.

19. The method of claim 1, wherein the plurality of graphene particles have a surface area ranging from about 300 m²/g to about 750 m²/g as measured by the BET method.

20. A system, comprising:
a classifier configured to feed a plurality of spherical graphite particles and a plurality of graphite particles rejected from a spheronization process into an airstream, the airstream configured to create at least two different particle trajectories to separate the plurality of spherical graphite particles from the plurality of graphite particles based on at least one of their size, shape or density;
a first collection zone configured to receive the plurality of spherical graphite particles; and
a second collection zone configured to receive the plurality of graphite particles, the second collection zone being different from the first collection zone.

21. The system of claim 20, further comprising:
one or more collection zone(s) configured to receive a plurality of spherical graphite particles having a different particle size D50 than particle size D50 of the plurality of spherical graphite particles received in the first collection zone.

22. The system of claim 20, wherein a flow rate of the airstream is from about 1,500 m³/hour to about 4,000 m³/hour for processing a total of about 2,000 kg of the plurality of spherical graphite particles and the plurality of graphite particles rejected from the spheronization process per hour.

23. The system of claim 22, wherein the flow rate of the airstream is from about 1,500 m³/hour to about 2,400 m³/hour.

24. The system of claim 20, further comprising:
an induced draft fan configured to generate the airstream.

25. The system of claim 20, further comprising:
a feed mechanism configured to deliver the plurality of spherical graphite particles and the plurality of graphite particles rejected from the spheronization process into the classifier, the feed mechanism configured to regulate a feed rate of the plurality of spherical graphite particles and the plurality of graphite particles rejected from the spheronization process.

26. The system of claim 20, further comprising:
a control mechanism configured to adjust a flow rate of the airstream by modifying at least one of the velocity or volume of airflow.
